(19) United States
(12) Patent Application Publication
(10) Pub. No.: US 2023/0081397 A1
(43) Pub. Date: Mar. 16, 2023

(54) ANTI-CORROSION SUPER-SLIPPERY ALUMINUM CAPILLARY TUBE AND METHOD AND DEVICE FOR PREPARING THE SAME

(71) Applicant: XI'AN JIAOTONG UNIVERSITY, Xi'an (CN)

(72) Inventors: Cunlu ZHAO, Xi'an (CN); Huilong YAN, Xi'an (CN); Yonghe CUI, Xi'an (CN); Kai JIAO, Xi'an (CN); Dongmin WEI, Xi'an (CN); Fang QIAN, Xi'an (CN); Qiuwang WANG, Xi'an (CN)

(21) Appl. No.: 17/944,227

(22) Filed: Sep. 14, 2022

(30) Foreign Application Priority Data
Sep. 14, 2021 (CN) 202111076747.1

(51) Int. Cl. F16L 9/02; C23C 22/56; C23F 1/20

(52) U.S. Cl. CPC F16L 9/02; C23C 22/56; C23F 1/20; C23C 2222/20

(57) ABSTRACT

The present application provides an anti-corrosion super-slippery aluminum capillary tube and method and device for preparing the same. The preparation starts with the etching and drying of the inner walls of an aluminum capillary tube, which leads to the formation of an alumina capillary structure surface with micro-nano scale roughness. Next, the alumina capillary structure surface is modified to form a low surface energy modifying layer. Finally, the modified alumina capillary structure surface is wetted by a prewetting solution, so that a continuous film of the prewetting solution is formed on the inner wall of the aluminum capillary tube to function as a lubricating layer. The lubrication layer, on one hand, reduces the flow resistance for convey of liquid media, on the other hand, prevents the conveyed liquids from directly contacting the aluminum capillary tube body, thereby avoiding the corrosion of the aluminum capillary tube by corrosive liquids.

### TECHNICAL FIELD

The present application relates to the technical field of microchannel flow, in particular to an anti-corrosion super-slippery aluminum capillary tube and method and device for preparing the same.

### BACKGROUND

In most industrial scenes, aluminum and alloy materials thereof are widely used because of their abundant raw materials, low price, strong plasticity, strong ductility, high strength and low density. Capillary tubes or microchannels with aluminum as a base material are widely used in heat exchangers such as aviation equipment, electronic devices, LED lighting devices and cold storage systems. In addition, aluminum-based capillary tubes also play an important role in the field of flowable material transportation in emerging equipment such as microelectromechanical systems and special agricultural machinery. Aluminum-based capillary tubes not only have the characteristics of low cost, easy integration and mass production, but also can reduce the invalid volume of equipment, reduce energy consumption and improve response speed due to small sizes. These unique advantages will further expand the present application of aluminum capillary tube as flowable material conveying channel.

However, there are two major problems in the practical application of aluminum-based capillary tubes.

Firstly, the base material, aluminum, of the capillary tubes is active, and it is easy to react with some liquids to cause corrosion, which will cause the capillary damage. The liquid causing aluminum corrosion includes some liquids with high thermal conductivity, such as high-concentration salt solutions, mercury, gallium-based liquid metals, and some acidic working fluids. These corrosive liquids are particularly necessary for many applications involving aluminum-based capillary tubes, such as heat exchangers and microelectromechanical systems.

Secondly, with the decrease of the hydraulic diameter of the aluminum capillary tube, the flow resistance of the flowable working medium intensifies, thereby leading to a sharp increase in the power consumption for the flowable medium transportation. As the viscosity of the fluid increases, this problem will become more and more obvious.

Therefore, how to achieve the efficient transportation of corrosive liquid materials, especially high-viscosity corrosive liquid materials, in aluminum capillary tubes remains one of the recognized problems in the field of micro-scale flow. This unsolved problem limits the further enrichment and expansion of the applications of aluminum-based capillary tubes.

### SUMMARY

In view of the problems in the prior art that the aluminum capillary tube is easy to corrode and has a large flow resistance in practical applications, the present application provides an anti-corrosion super-slippery aluminum capillary tube and method and device for preparing the same. The aluminum capillary tube has excellent performance, long service life, low manufacturing cost, and simple, reliable and safe manufacturing process.

The present application is realized by the following technical solution:

In one aspect, the present application provides an anti-corrosion super-slippery aluminum capillary tube, including:

an aluminum capillary tube body;

an alumina capillary structure surface with micro-nano scale roughness formed by etching an inner wall of the aluminum capillary tube body;

and a surface prewetting solution adhering, by wetting, to the alumina capillary structure surface.

In a second aspect, the present application provides a method for preparing an anti-corrosion super-slippery aluminum capillary tube, including:

cleaning and removing a naturally generated oxide layer on the inner wall of the aluminum capillary tube body for pretreatment;

etching the inner wall of the aluminum capillary tube body after the pretreatment by chemical etching under the action of heating and ultrasound to form a capillary structure surface with micro-nano scale roughness, and cleaning the capillary structure surface;

drying the moisture of the capillary structure surface at a temperature of 60° C. to 165° C., thereby forming the alumina capillary structure surface;

adhering, by wetting, the prewetting solution to the alumina capillary structure surface to obtain the anti-corrosion super-slippery aluminum capillary tube.

In a third aspect, the present application provides a device for preparing an anti-corrosion super-slippery aluminum capillary tube, including:

an ultrasonic cleaning pool provided with a heating device configured for placing an aluminum capillary tube body for ultrasonic oscillation and heating;

hoses respectively connected to two ends of the aluminum capillary tube body;

a reagent source connected with the hose at one end, wherein the reagent source comprises a cleaning liquid, an etching liquid and a surface prewetting solution that are arranged independently in sequence.

and a driving pump arranged on the hose connected with the reagent source.

Compared with the prior art, the present application has the following beneficial technical effects.

The present application provides an anti-corrosion super-slippery aluminum capillary tube which can be used for efficiently conveying corrosive fluid with a high viscosity. An alumina capillary structure surface with micro-nano scale roughness is formed by etching, and a prewetting solution sticks on the alumina capillary structure surface, so that a continuous film of the prewetting solution is formed on the inner wall of the aluminum capillary tube body to function as a lubricating layer. At the same time, the prewetting solution that is immiscible with the conveyed liquid prevents the conveyed liquid from directly contacting the aluminum capillary tube body, and then prevents the corrosion of the aluminum capillary tube body by the conveyed liquid. In brief, the aluminum capillary tube has anti-corrosion effect, which allows for the transportation of corrosive flowable working medium, and the flow resistance is small, so that the aluminum capillary tube can efficiently transport the corrosive flowable working medium with a reduced power consumption, and thus has a broad application prospect.

The present application provides a method for preparing an anti-corrosion super-slippery aluminum capillary tube which can be used for efficiently conveying a corrosive fluid with a high viscosity. The preparation method is simple and reliable, and does not involve electrochemical reaction; in the preparation and reaction process, the aluminum capillary tube needs to be immersed or pumped into the corresponding liquid, so the diameter selection is flexible, and it is also suitable for the aluminum capillary tubes with complex structures such as multi-elbow and variable cross-section. The introduction of the prewetting solution layer can effectively protect the aluminum capillary tube from being corroded by the corrosive flowing working medium, and can realize the transmission of the corrosive flowing working medium by the aluminum capillary tube; at the same time, due to the low viscosity of the prewetting solution layer, it can provide an extremely high sliding length, thus effectively lubricating and reducing the resistance for the flow, and further greatly reducing the driving power consumption required by the high-viscosity flowing working medium when flowing in the aluminum capillary tube; the purposes of low manufacturing cost, high reliability, simple manufacturing process, long service life of components, excellent fluidity and the like are achieved.

Furthermore, by introducing the low surface energy modified layer cooperated with the complex alumina capillary structure surface formed by etching, the adhesion of the anti-corrosion prewetting solution layer can be made firmer under the double action of the capillary force and the van der Waals force, so that the super-slippery aluminum capillary tube can bear the larger flow rate of the flowing working medium without failure.

Furthermore, different prewetting solution layers can be selected according to different corrosive working fluids to protect the aluminum capillary tubes.

### BRIEF DESCRIPTION OF DRAWINGS

FIG. 1 is a schematic cross-sectional view of the structure of an anti-corrosion super-slippery aluminum capillary tube in an example of the present application;

in the figure: aluminum capillary tube body 1, alumina capillary structure surface 2, low surface energy modified layer 3, surface pre-wetting fluid 4, and high viscosity corrosive flowing working medium 5.

FIG. 2 is a structural schematic diagram of a device for preparing the anti-corrosion super-slippery aluminum capillary tube in an example of the present application;

in the figure: ultrasonic cleaning pool 21, hose 22, reagent source 23, driving pump 24, oil bath 25, waste liquid tank 26, hotplate 27.

FIG. 3 is a graph showing the pressure loss and flow rate of deionized water flowing in an aluminum capillary tube with an inner diameter of 652 μm and a length of 10 cm in an example of the present application.

FIG. 4 is a comparative diagram of the embrittlement reaction of the gallium-based liquid metal in the anti-corrosion super-slippery aluminum capillary tube and a common aluminum tube in an example of the present application.

FIG. 5 is a graph showing the relationship between the pressure loss and flow rate of the gallium-based liquid metal flowing in an anti-corrosion super-slippery aluminum capillary tube with an inner diameter of 686 μm and a length of 10 cm.

FIG. 6 shows the micro-morphology (SEM) and element composition (EDS) of the inner wall of the pretreated aluminum capillary tube.

FIG. 7 shows the micro-morphology (SEM) and element composition (EDS) of the inner wall of the etched aluminum capillary tube in an example of the present application.

FIG. 8 is a schematic diagram of the bonding mechanism between the inner wall of the etched aluminum capillary tube and perfluorooctyltrichlorosilane in an example of the present application.

FIG. 9 shows the micro-morphology (SEM) and element composition (EDS) of the inner wall of the modified aluminum capillary tube in an example of the present application.

FIG. 10 shows the micro-morphology (SEM) and element composition (EDS) of the inner wall of the aluminum capillary tube after the prewetting solution infusing treatment in an example of the present application.

FIG. 11 shows a schematic diagram of the geometric dimensions of the right-angle bent aluminum capillary tube in an example of the present application.

FIG. 12 is a graph showing the relationship between pressure loss and flow rate of the deionized water flowing in a right-angle bent aluminum capillary tube with an inner diameter of 764 μm in an example of the present application.

FIG. 13 is a graph showing the relationship between pressure loss and flow rate of the gallium-based liquid metal flowing in an anti-corrosion super-slippery right-angle bent aluminum capillary tube with an inner diameter of 764 μm in an example of the present application.

### DESCRIPTION OF EMBODIMENTS

The present application will be further explained in detail with reference to the following specific examples, which are intended to explain, rather than limit, present application.

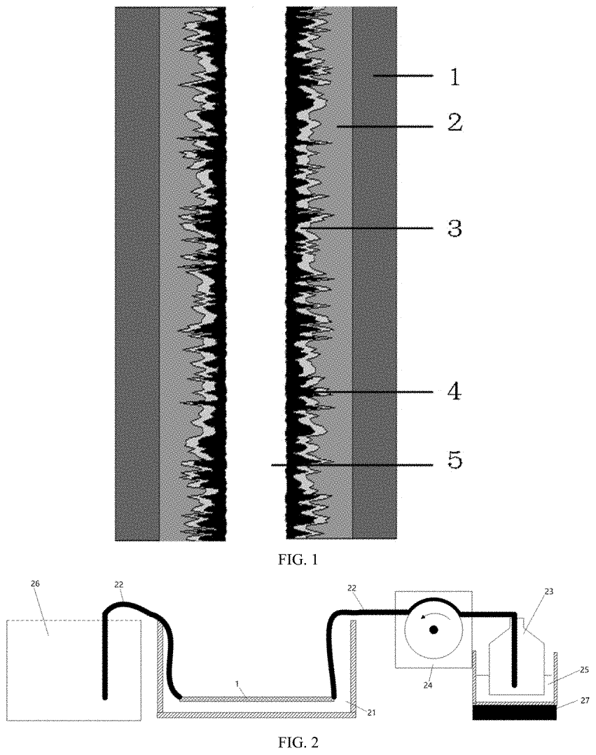

As shown in FIG. 1, the anti-corrosion super-slippery aluminum capillary tube of the present application includes an aluminum capillary tube body 1; an alumina capillary structure surface 2 with a micro-nano scale roughness formed by etching the inner wall of the aluminum capillary tube body 1; and a surface prewetting solution 4 adhering, by wetting, to the alumina capillary structure surface 2; wherein the aluminum capillary tube body 1 is actually the base of the aluminum capillary tube. As the basis of the present application, a dense aluminum oxide protective layer with a special structure is formed on its inner wall by etching, and the special structure is a capillary structure with a micro-nano scale roughness, thereby forming an aluminum oxide capillary structure surface 2 with a complicated and irregular inner wall, which is used to allow the adhesion of the prewetting solution 4 by capillary force, thus forming a continuous liquid film, namely the prewetting solution layer, to achieve corrosion protection while lubricating, and to isolate the high-viscosity corrosive flowing working medium 5.

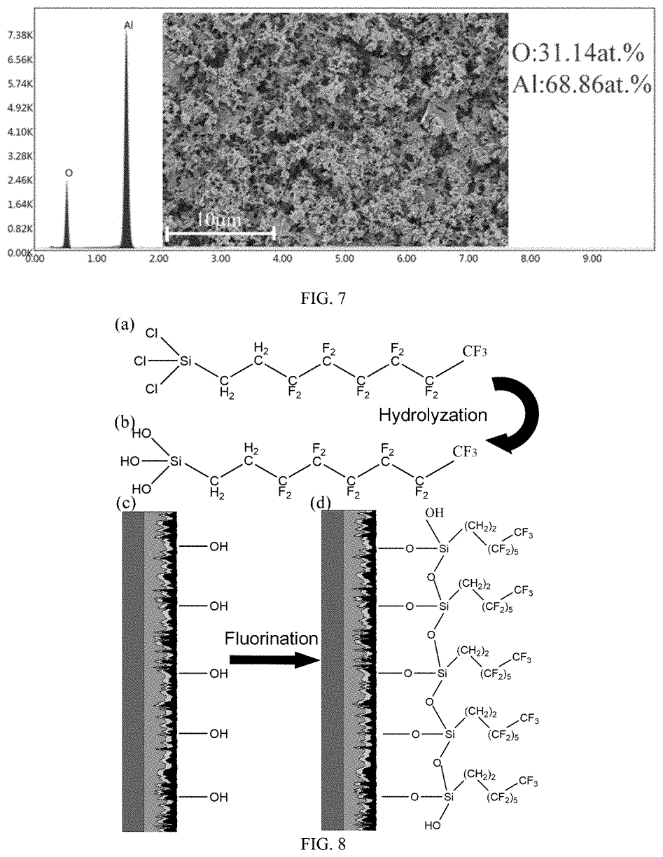

Generally speaking, a micro-scale means that the feature size is between 1 and 1000 μm; a nano-scale means that the feature size of 1-1000 nm. The micro-nano scale in the present application refers specifically to the micro-scale pores with the feature size of 1-8 μm prepared in FIG. 7 and the nano-scale pores with the feature size of 30-380 nm nested in the micro-scale pores, and the two nested pores form the capillary structure of the inner surface of the aluminum capillary tube body 1.

In this preferred example, the alumina capillary structure surface 2 is modified by stearic acid, palmitic acid or fluorosilane to form a low surface energy modified layer 3; as shown in FIG. 1, the surface prewetting solution 4 is adheres, by wetting, to the low surface energy modified layer 3. As shown in FIG. 1, a low surface energy modified substance adheres to the inner wall of the aluminum capillary tube with the alumina capillary structure surface through deposition and reaction to form the low surface energy modified layer 3. The alumina capillary structure surface 2 can effectively increase the adhesion amount of the low surface energy substance, and the low surface energy modified layer 3 can provide Van der Waals force without changing the morphology and structure of the alumina capillary structure surface, thereby forming a double effect by cooperating with the capillary force to make the low-viscosity, anti-corrosion pre-wet lubricating oil adheres to the inner wall surface of the modified aluminum capillary tube and form an aluminum capillary tube with an inner wall of a slippery liquid infused porous surface (SLIPS), wherein, the surface prewetting solution is preferably perfluoropolyether oil or dimethyl silicone oil with a viscosity of 10-1000 Cst.

The inner diameter of the aluminum capillary tube body 1 in the present application is preferably 200-1000 μm. In fact, the diameter can be flexibly selected, so long as the reaction reagent can smoothly circulate in the aluminum capillary tube, and it can be applied to the structure of nano-grade aluminum capillary tubes. At the same time, it is not limited to the preparation of conventional straight aluminum capillary tubes, but also applicable to the structure of multi-elbow, variable cross-section and other complicated aluminum capillary tubes.

The present application also provides a method for preparing an anti-corrosion super-slippery aluminum capillary tube, which includes that follow steps: etching and drying an inner wall of an aluminum capillary tube body 1 after a pretreatment to form an alumina capillary structure surface 2 with a micro-nano scale roughness; a prewetting solution 4 adhering, by wetting, to the alumina capillary structure surface 2 to obtain the anti-corrosion super-slippery aluminum capillary tube.

The present application provides an anti-corrosion super-slippery aluminum capillary tube which can be used for transporting high-viscosity and corrosive fluids and a preparation method thereof. The anti-corrosion super-slippery aluminum capillary tube is an aluminum capillary tube with a smooth inner wall of a slippery liquid infused porous surface (SLIPS), which can effectively strengthen the flow of the high-viscosity fluid in the capillary and prevent the corrosive fluid from corroding the tube wall when flowing in the aluminum capillary tube. It overcomes the problems that the preparation of traditional aluminum-based surface capillary structure needs electrochemical reactions, the parameters such as current, temperature, voltage, etc. change sharply in the reaction process, and when the inner diameter of the aluminum capillary tube is too small, it is difficult to insert into the reaction electrode. The preparation method of the anti-corrosion super-slippery aluminum capillary tube does not involve electrode insertion in the whole preparation process, and only the reaction solution needs to be circulated. It is simple and flexible, and is suitable for large-scale popularization. It is not only suitable for the preparation of conventional straight aluminum capillary tubes, but also widely suitable for the preparation of aluminum capillary tubes with variable cross-sections, multiple elbows and various tube diameters. At the same time, the diameter of the aluminum capillary tube is flexible, and it can be prepared as long as the reaction reagent can flow smoothly in the aluminum capillary tube. In principle, it can be applied to the preparation of nano-grade aluminum capillary tubes.

By taking the preparation of the aluminum capillary tube with an inner diameter of 200-1000 μm as an example, first, the inner wall of the aluminum capillary tube was cleaned by chemical etching to remove the oxide layer. Secondly, the capillary structure with a micro-nano roughness was prepared on the inner wall surface of the aluminum capillary tube by chemical etching. Finally, the low viscosity and anti-corrosion lubricating oil adhered to the inner wall surface of the modified aluminum capillary tube by the double action of capillary force and Van der Waals force, and the aluminum capillary tube with a SLIPS inner wall was prepared. It solves the problem of efficient transportation of corrosive liquid materials, especially high-viscosity corrosive liquid materials, in the micro-scale flow field, and is helpful to further enrich and expand the application functions of aluminum-based capillary tubes.

In the method, tearic acid, palmitic acid or fluorosilane can also be used to modify the inner wall surface of the aluminum capillary tube, so that a layer of a substance with low surface energy adheres to the inner wall surface of the aluminum capillary tube, and the pre-wetting layer can be better adhere to the inner wall surface of the aluminum capillary tube body 1.

On the basis of the above method, further explanation will be made by the following examples of specific steps.

It should be noted here that, in order to better realize the method, the present application also provides a device for preparing the anti-corrosion super-slippery aluminum capillary tube, as shown in FIG. 2, which includes an ultrasonic cleaning pool 21 provided with a heating device for placing the aluminum capillary tube body 1 for ultrasonic oscillation and heating; hoses 22 respectively connecting the two ends of the aluminum capillary tube body 1; wherein a hose 22 at one end of the aluminum capillary tube body 1 is connected with a reagent source 23, and the reagent source 23 includes a cleaning solution, an etching solution and a surface pre-wetting solution 4 that are arranged independently in parallel; and a driving pump 24 disposed on the hose 22 connected to the reagent source 23.

The reagent source 23 is placed in an oil bath 25 with a hotplate 27, the hose 22 at the other end of the aluminum capillary tube body 1 is communicated with a waste liquid pool 26, and the hose 22 is made of anti-corrosion silicone tube; the driving pump 24 can be a peristaltic pump; the reagent source 23 is a reagent bottle filled with a corresponding liquid.

The above device or system and device with the same structure are used to prepare the anti-corrosion and super-slippery aluminum capillary tubes, mainly for cleaning, ultrasonic, heating and infusing operations.

An aluminum capillary tube with an inner diameter of 200-1000 μm was cut to an appropriate length, and a high-elasticity anti-corrosion silicone tube was used to connect both ends of the treated aluminum capillary tube, one end of which was connected to the waste liquid pool 26 for storing the reacted reagent, and the other end of which was connected to the reagent source 23 for supplying the reacted reagent, and was specifically communicated with the reagent bottle, and a peristaltic pump was used to provide driving force for the flowing of the reacted reagent through the high-elasticity anti-corrosion silicone tube. The reagent was pumped from the reagent bottle by the peristaltic pump and flowed into the aluminum capillary tube through the silicone tube for reaction, and the reacted reagent flowed into the waste liquid pool 26 through the silicone tube. The purpose of placing the aluminum capillary tube in the ultrasonic cleaning pool 21 was to induce the reaction reagent in the aluminum capillary tube to oscillate by ultrasonic waves, which was conducive to the full contact between the reaction reagent and the inner wall of the aluminum capillary tube for complete reaction. The ultrasonic cleaning pool 21 in this experimental device was equipped with a controllable heating module, and its temperature was consistent with the temperature set by the hotplate, so that the temperature of the reaction reagent could be kept constant when it reacted with the inner wall of the aluminum capillary tube. The temperature of the ultrasonic cleaning pool 21 described later was consistent with the hotplate, which will not be repeated. If the heating temperature is not indicated, it means that the reaction is carried out at room temperature. The specific device is shown in FIG. 2. The flow rate of the peristaltic pump is determined by the reaction severity, the diameter of the tube and the suitable silicone tube, and the range is 0.1-720 mL/min.

I, Pretreatment of the Aluminum Capillary Tube.

The pretreatment is cleaning and removing the naturally generated oxide layer on the inner wall of the aluminum capillary tube body 1. Because the inner wall of the aluminum capillary tube will contain impurities such as oil stain that will affect the subsequent reaction, it is necessary to pretreat the surface. This preferred example provides two treatment solutions.

The steps of solution 1.1 are as follows:

S111, after adding acetone into a reagent bottle, the peristaltic pump was started according to the direction shown in FIG. 2, the ultrasonic frequency was set to 40-120 kHz, ultrasonic oscillation was continued during the process of introducing the reagent, and the time was for 5-30 min;

S112, for the above treated aluminum capillary tube, after adding alcohol into the reagent bottle, the peristaltic pump was started according to the direction shown in FIG. 2, the ultrasonic frequency was set to 40-120 kHz, ultrasonic oscillation in the process of introducing the reagent, and the time was 10-35 min;

S113, for the above treated aluminum capillary tube, after adding deionized water to the reagent bottle, the peristaltic pump was started according to the direction shown in FIG. 2, the ultrasonic frequency was set to 40-120 kHz, ultrasonic oscillation was continued during the process of introducing the reagent, and the time was 5-25 min;

S114, for the above treated aluminum capillary tube, after adding 1.25-4.5 mol/L of hydrofluoric acid to the reagent bottle, the peristaltic pump was started according to the direction shown in FIG. 2, the ultrasonic frequency was set to 20-40 kHz, and the ultrasonic oscillation was continued during the process of introducing the reagent, and the reaction time was 5-20 minutes; the purpose of this step was to remove the naturally generated oxide layer on the inner wall surface of the aluminum capillary tube;

S115, for the above treated aluminum capillary tube, the reagent in the reagent bottle was replaced with deionized water, the peristaltic pump was started according to the direction shown in FIG. 2, the ultrasonic frequency was set to 40-120 kHz, ultrasonic oscillation was continued during the process of introducing deionized water, and the cleaning time was 5-20 minutes; the purpose of this step was to remove excess hydrofluoric acid from the inner wall of the aluminum capillary tube.

What shall be noted in the above treatment is as follows: first, hydrofluoric acid has a strong corrosive effect on glassware, so the reagent bottle and waste bottle used in step S114 are different from those in steps S111-S113 and S115 in that the reagent bottle and waste bottle used in step S114 are made of plastic, while the reagent bottle and waste bottle used in steps S111-S113 and S115 are made of glass; secondly, the higher the hydrofluoric acid concentration, the shorter the corresponding reaction time, and the longer the reaction time, the easier it is to corrode the aluminum capillary tube excessively; thirdly, after removing the oxide layer on the inner wall of the aluminum capillary tube with hydrofluoric acid (step S114 above), the hydrofluoric acid in the reagent bottle should be replaced with deionized water as soon as possible to avoid excessive corrosion on the inner wall of the aluminum capillary tube.

The steps of Solution 1.2 are as follows: Steps S121-S123 were the same as those in Solution S111; S124, after adding 0.3-12 mol/L of sodium hydroxide into the reagent bottle, the peristaltic pump was started according to the direction shown in FIG. 2, the ultrasonic frequency was set to 20-40 kHz, and ultrasonic oscillation was continued in the process of introducing the reagent, and the reaction time was 0.5-15 min; the purpose of this step was to remove the naturally produced oxide layer on the surface; S125 was the same as that in Solution 1.1.

II, Chemical Etching of the Inner Wall of the Aluminum Capillary Tube.

According to the present application, the inner wall of the pretreated aluminum capillary tube body 1 was etched and dried to form an alumina capillary structure surface 2 with a micro-nano scale roughness, and the treatment steps included: etching the inner wall of the aluminum capillary tube body 1 by chemical etching under the action of heating and ultrasound to form a capillary structure with micro-nano scale roughness, and cleaning; drying the surface moisture of the capillary structure at a temperature of 60-165° C., and simultaneously forming the alumina capillary structure surface 2.

During the actual treatment, the inner wall of the pretreated aluminum capillary tube body 1 was etched and dried by any of the following methods to form an alumina capillary structure surface 2 with a micro-nano scale roughness;

a, under a pumping flow rate of 5-120 mL/min and an ultrasonic frequency of 40-120 kHz, 2.5-6 mol/L hydrochloric acid was fed into the aluminum capillary tube body 1 for etching, and reaction was carried out under continuous ultrasonic oscillation for 5-30 min; after the reaction was finished and cleaning was carried out, drying was carried out at a temperature of 120-165° C. for 3-15 min;

b, under a pumping flow rate of 5-240 mL/min and an ultrasonic frequency of 40-120 kHz, a mixed solution of 0.005-1 mol/L copper nitrate and 0.1-4 mol/L sodium chloride was fed into the aluminum capillary tube body 1 for etching, and the mixture was subjected to continuous ultrasonic oscillation and reacted for 35-160 min at a temperature of 30-55° C.; after the reaction was finished and cleaning was carried out, drying at a temperature of 60-100° C. for 30-120 min;

c, under a pumping flow rate of 5-240 mL/min and an ultrasonic frequency of 40-120 kHz, a mixed solution of 0.15-0.5 mol/L oxalic acid and 0.1-2 mol/L sodium chloride was fed into the aluminum capillary tube body 1 for etching, and the mixture was subjected to continuous ultrasonic oscillation and reacted for 8-16 h at a temperature of 30-55° C.; after the reaction is finished and cleaning was carried out, drying at a temperature of 60-100° C. for 30-120 min;

d, under a pumping flow rate of 5-240 mL/min and an ultrasonic frequency of 40-120 kHz, a mixed solution of 0.35-0.95 mol/L phosphoric acid, 0.05-0.25 mol/L sodium chloride and 0.05-0.2 mol/L chromium trioxide was fed into the aluminum capillary tube body 1 for etching, and the mixture was subjected to continuous ultrasonic oscillation and reacted for 5-20 min at a temperature of 30-45° C.; after the reaction was finished and cleaning was carried out, drying at a temperature of 60-100° C. for 30-120 min;

e, under a pumping flow rate of 5-240 mL/min and an ultrasonic frequency of 40-120 kHz, a 0.5-2 mol/L ferric chloride solution was fed into the aluminum capillary tube body 1 for etching, and reaction was carried out under continuous ultrasonic oscillation for 0.5-60 min; was finished and cleaning was carried out after the reaction is finished and cleaning was carried out, drying at a temperature of 60-80° C. for 30-80 min;

f, under a pumping flow rate of 5-240 mL/min and an ultrasonic frequency of 40-120 kHz, a mixed solution of 0.01-0.4 mol/L oxalic acid and 0.2-2 mol/L hydrochloric acid was fed into the aluminum capillary tube body 1 for primary etching, and the reaction was carried out under continuous ultrasonic oscillation for 8-24 h; after the primary etching reaction was finished and cleaning was carried out, a 0.2-0.8 mol/L potassium permanganate solution was fed into the aluminum capillary tube body 1 for secondary etching at a pumping flow rate of 5-240 mL/min and an ultrasonic frequency of 40-120 kHz, and the reaction was carried out at a temperature of 30-45° C. for 0.5-2 hours under continuous ultrasonic oscillation; after the secondary etching reaction was finished and cleaning was carried out, drying at a temperature of 60-80° C. for 30-80 min;

g, under a pumping flow rate of 5-240 mL/min and an ultrasonic frequency of 40-120 kHz, a 0.5-12 mol/L sodium hydroxide solution was fed into the aluminum capillary tube body 1 for primary etching, and the reaction was carried out under continuous ultrasonic oscillation for 10-60 min; after the primary etching reaction was finished and cleaning was carried out, drying for 30-80 min at a temperature of 60-80° C.; after primary drying, a mixed solution of 0.005-0.025 mol/L zinc nitrate hexahydrate and 0.005-0.05 mol/L sodium citrate was fed into the aluminum capillary tube body 1 for secondary etching under a pumping flow rate of 5-240 mL/min and an ultrasonic frequency of 40-120 kHz, and the mixture was subjected to continuous ultrasonic oscillation and reaction at a temperature of 60-90° C. for 20-80 min; after the secondary etching reaction was finished and cleaning was carried out, drying at a temperature of 60-80° C. for 30-80 min.

The inner wall of the aluminum capillary tube was chemically etched by using solutions with various components and different proportions, in order to form a capillary structure with a micro-nano scale roughness on the inner wall of the aluminum capillary tube. The used device is also shown in FIG. 2, but it is not limited to FIG. 2. Corresponding to the etching treatment method, the present application provides the following seven treatment solutions, which are as follows:

The steps of Solution 2.1 are as follows: S211, the pretreated sample from which the oxide layer on the surface of the aluminum capillary tube was removed was taken for treatment, 2.5-6 mol/L hydrochloric acid was added into a reagent bottle, the peristaltic pump was started according to the direction as shown in FIG. 2, with a pumping flow rate of 5-120 mL/min and an ultrasonic frequency of 40-120 kHz; and ultrasonic oscillation was continued during the process of introducing the reagents, and the reaction time was 5-30 min; S212, steps S111-S113 were repeated to clean the surface of the chemically etched aluminum capillary tube, and then the tube was put into a high-temperature oven at 120-165° C. for high-temperature treatment for 3-15 min to remove the moisture on the inner wall surface of the aluminum capillary tube.

The steps of Solution 2.2 are as follows: S221, the pretreated sample from which the oxide layer on the surface of the aluminum capillary tube was removed taken for treatment, a mixed solution of 0.005-1 mol/L copper nitrate and 0.1-4 mol/L sodium chloride was added into a reagent bottle, and the peristaltic pump was started according to the direction as shown in FIG. 2, with a pumping flow rate of 5-240 mL/min and an ultrasonic frequency of 40-120 kHz; ultrasonic oscillation was continued in the process of introducing the reagents, the reaction time was 35-160 min, and the temperature of that hotplate was 30-55° C.; S222, steps S111-S113 were repeated to clean the chemically etched aluminum capillary tube surface, and then the tube was dried in an oven at 60-100° C. for 30-120 min to remove the moisture on the inner wall surface of the aluminum capillary tube.

The steps of Solution 2.3 are as follows: S231, the pretreated sample from which the oxide layer on the surface of the aluminum capillary tube was removed was taken for treatment, a the mixed solution of 0.15-0.5 mol/L oxalic acid and 0.1-2 mol/L sodium chloride was added into a reagent bottle, and the peristaltic pump was started according to the direction as shown in FIG. 2, with a pumping flow rate of 5-240 mL/min and an ultrasonic frequency of 40-120 kHz; ultrasonic oscillation was continued during the process of introducing the reagents, the reaction time was 8-16 h, and the temperature of that hotplate was 30-55° C.; S232, steps S111-S113 were repeated to clean the inner wall surface of the treated aluminum capillary tube, and then the tube was dried in an oven at 60-100° C. for 30-120 min to remove the moisture on the inner wall surface of the aluminum capillary tube.

The steps of Solution 2.4 are as follows: S241, the pretreated sample from which the oxide layer on the surface of the aluminum capillary tube was removed was taken for treatment, a mixed solution of 0.35-0.95 mol/L phosphoric acid, 0.05-0.25 mol/L sodium chloride and 0.05-0.2 mol/L chromium trioxide was added into a reagent bottle, and then the peristaltic pump was started according to the direction as shown in FIG. 2, with a pumping flow rate of 5-240 mL/min and an ultrasonic frequency of 40-120 kHz; ultrasonic oscillation was continued during the process of introducing the reagents, the reaction time was 5-20 min, and the temperature of that hotplate was 30-45° C.; S242, steps S111-S113 were repeated to clean the inner wall surface of the treated aluminum capillary tube, and then the tube was dried in an oven at 60-100° C. for 30-120 min to remove the moisture on the inner wall surface of the aluminum capillary tube.

The steps of Solution 2.5 are as follows: S251, the pretreated sample from which the oxide layer on the surface of the aluminum capillary tube was removed was taken for treatment, a 0.5-2 mol/L ferric chloride solution was added into the reagent bottle, the peristaltic pump was started according to the direction shown in FIG. 2, with a pumping flow rate of 5-240 mL/min and an ultrasonic frequency of 40-120 kHz; ultrasonic oscillation was continued during the process of introducing the reagents, and the reaction time was 0.5-60 min; S252, steps S111-S113 were repeated to clean the inner wall surface of the treated aluminum capillary tube, and then the treated aluminum capillary tube with water on the inner wall surface was put into an oven at 60-80° C. and dried for 30-80 min.

The steps of Solution 2.6 are as follows: S261, the pretreated sample from which the oxide layer on the surface of the aluminum capillary tube was removed was taken for treatment, a mixed solution of 0.01-0.4 mol/L oxalic acid and 0.2-2 mol/L hydrochloric acid was added into the reagent bottle, and the peristaltic pump was started according to the direction as shown in FIG. 2, with a pumping flow rate of 5-240 mL/min and an ultrasonic frequency of 40-120 kHz; ultrasonic oscillation was continued during the process of introducing the reagents, and the reaction time was 8-24 h; S262, steps S111-S113 were repeated to clean the inner wall surface of the treated aluminum capillary tube; S263, the above treated aluminum capillary tube was taken for treatment, a 0.2-0.8 mol/L potassium permanganate solution was added into a reagent bottle, then the peristaltic pump was started according to the direction as shown in FIG. 2, with a pumping flow rate of 5-240 mL/min and an ultrasonic frequency of 40-120 kHz; the ultrasonic oscillation was continued during the process of introducing the reagents, the reaction time was 0.5-2 hours, and the temperature of the hotplate was 30-45° C.; S264, steps S111-S113 were repeated to clean the inner wall surface of the treated aluminum capillary tube, and the treated aluminum capillary tube containing water on the inner wall surface was put into an oven at 60-80° C. for drying for 30-80 min.

The steps of Solution 2.7 are as follows: S271, the pretreated sample from which the oxidized layer on the surface of the aluminum capillary tube was removed was taken for treatment, a 0.5-12 mol/L sodium hydroxide solution was added into a reagent bottle, the peristaltic pump was started according to the direction as shown in FIG. 2, with a pumping flow rate of 5-240 mL/min and an ultrasonic frequency of 40-120 kHz; ultrasonic oscillation was continued in the process of introducing the reagents, and the reaction time was 10-60 min; S272, steps S111-S113 were repeated to clean the inner wall surface of the treated aluminum capillary tube, and the treated aluminum capillary tube containing water on the inner wall surface was put into an oven at 60-80° C. for drying for 30-80 min; S273, the above treated aluminum capillary tube was taken for treatment, a mixed solution of 0.005-0.025 mol/L zinc nitrate hexahydrate and 0.005-0.05 mol/L sodium citrate was added into a reagent bottle, and then the peristaltic pump was started according to the direction as shown in FIG. 2, with a pumping flow rate of 5-240 mL/min and an ultrasonic frequency of 40-120 kHz; ultrasonic oscillation was continued in the process of introducing the reagents; S274, steps S111-S113 were repeated to clean the inner wall surface of the treated aluminum capillary tube, and the treated aluminum capillary tube containing water on the inner wall surface was put into an oven at 60-80° C. for drying for 30-80 min.

The main purpose of the above seven solutions is to form a dense alumina protective layer with a certain thickness on the inner wall surface of the aluminum capillary tube, and make it have a capillary structure with a micro-nano scale roughness, as shown in FIG. 2. The capillary structure with a micro-nano scale roughness increases the surface area of the inner wall of the aluminum capillary tube, which lays the foundation for the subsequent treatment steps.

III, Modification of the Inner Wall of Aluminum Capillary Tube.

This step can be added or omitted. Addition of this step can better facilitate the absorption of the subsequent prewetting solution and keeping the integrity and firmness of the liquid film; omission of this step will not affect the realization of the concept of the present application itself; this step is a step of modifying the alumina capillary structure surface 2 by stearic acid, palmitic acid or fluorosilane under the action of heating and ultrasound, and forming a low surface energy modified layer 3 after modification; the surface prewetting solution 4 adheres, by wetting, to the alumina capillary structure surface 2 forming the low surface energy modified layer 3.

During actual treatment, in the step of modifying the alumina capillary structure surface 2 by stearic acid, palmitic acid or fluorosilane under the action of heating and ultrasound, and forming a low surface energy modified layer 3 after modification, any of the following method is specifically adopted for modification;

a. under a pumping flow rate of 5-120 mL/min and an ultrasonic frequency of 40-120 kHz, a 0.5-5 wt. % perfluorodecyltriethoxysilane solution in ethanol was fed into the aluminum capillary tube body 1 to modify the alumina capillary structure surface 2, and the ultrasonic oscillation was continued and reaction was carried out for 5-900 min at a temperature of 60-95° C.; after the reaction was finished and cleaning was carried out, drying was carried out at 60-160° C. for 20-80 min;

b, under a pumping flow rate of 5-120 mL/min and an ultrasonic frequency of 40-120 kHz, an 0.05 mol/L stearic acid solution in ethanol was fed into the aluminum capillary tube body 1 to modify the alumina capillary structure surface 2, the ultrasonic oscillation was continued, and the reaction was carried out at a temperature of 60-95° C. for 5-900 min; after the reaction was finished and cleaning was carried out and cleaning was carried out, drying was carried out at 60-160° C. for 20-80 min;

c, under a pumping flow rate of 5-120 mL/min and an ultrasonic frequency of 40-120 kHz, a 0.5-5 wt. % perfluorooctyltrichlorosilane solution in ethanol was fed into the aluminum capillary tube body 1 to modify the alumina capillary structure surface 2, the ultrasonic oscillation was continued, and the reaction was carried out at a temperature of 60-95° C. for 5-900 min; after the reaction was finished and cleaning was carried out, drying was carried out at 60-160° C. for 20-80 min.

Specifically, there are two main ways of modification, that is, surface modification with fluorosilane, such as perfluorodecyltriethoxysilane, perfluorooctyltrichlorosilane, heptafluorodecyltrimethoxysilane and perfluorooctyltriethoxysilane, or surface modification with stearic acid and palmitic acid. Corresponding to the modification treatment methods, the example of the present application provides the following three treatment solutions,

The steps of Solution 3.1 are as follows: S311, a sample with a rough capillary structure on the inner wall of the chemically etched aluminum capillary tube was taken for treatment, a 0.5-5 wt. % ethanol solution of perfluorodecyltriethoxysilane was added into a reagent bottle, then the peristaltic pump was started according to the direction shown in FIG. 2, with a pumping flow rate of 5-120 mL/min, the temperatures of the hotplate and ultrasonic cleaning pool 21 were set at 60-95° C., and the ultrasonic frequency was set at 40-120 kHz; the ultrasonic oscillation was continued in the process of introducing reagents, and the reaction time was 5-900 min; S312, the treated aluminum capillary tube was put into an oven at 60-160° C. for drying for 20-80 min.

The steps of Solution 3.2 are as follows: S321, a sample with a rough capillary structure on the inner wall of the chemically etched aluminum capillary tube was taken for treatment, a 0.05 mol/L stearic acid ethanol solution was added into a reagent bottle, the peristaltic pump was started according to the direction shown in FIG. 2, with a pumping flow rate of 5-120 mL/min, the temperatures of the hotplate and the ultrasonic cleaning pool 21 were set at 60-95° C., and the ultrasonic frequency was set at 40-120 kHz; the ultrasonic oscillation was continued in the process of introducing reagents, and the reaction time was 5-900 min; S322, the treated aluminum capillary tube was put into an oven at 60-160° C. for drying for 20-80 min.

The steps of Solution 3.3 are as follows: S331, a sample with a rough capillary structure on the inner wall of the chemically etched aluminum capillary tube was taken for treatment, a 0.5-5 wt. % ethanol solution of perfluorooctyltrichlorosilane was added into a reagent bottle, and the peristaltic pump was started according to the direction as shown in FIG. 2, with a pumping flow rate of 5-120 mL/min, the temperatures of the hotplate and the ultrasonic cleaning pool 21 were set at 60-95° C., and the ultrasonic frequency was set at 40-120 kHz; the ultrasonic oscillation was continued in the process of introducing reagents, and the reaction time was 5-900 min; S332, the treated aluminum capillary tube was put into an oven at 60-160° C. for drying for 20-80 min.

The main purpose of the above three solutions is to form a low surface energy modified layer 3 as shown in FIG. 2 on the rough capillary structure surface of the inner wall of the aluminum capillary tube, which is conducive to the firm adhesion of the subsequent prewetting solution.

IV, Infusing of Surface Prewetting Solution 4.

According to the present application, the surface prewetting solution 4 adheres, by wetting, to the alumina capillary structure surface 2, and two kinds of surface prewetting solution 4 are mainly selected, namely, low-viscosity perfluoropolyether oil and low-viscosity dimethyl silicone oil, both of which have the advantages of firm adhesion to the inner wall of the modified aluminum capillary tube, strong corrosion resistance and low viscosity. In this preferred example, perfluoropolyether oil or dimethyl silicone oil with a viscosity of 10-1000 Cst is used as the surface prewetting solution 4, which is wetted and adheres to the alumina capillary structure surface 2 under the action of ultrasonic oscillation.

Specifically, under a pumping flow rate of 5-120 mL/min and an ultrasonic frequency of 40-120 kHz, perfluoropolyether oil or dimethyl silicone oil with a viscosity of 10-1000 Cst was fed into the aluminum capillary tube body 1, the surface prewetting solution 4 was infused on the alumina capillary structure surface 2, and the reaction lasted for 0.5-18 hours under ultrasonic oscillation; after the reaction was finished, the aluminum capillary tube body 1 was vertically placed for 10-60 min, so that the excess perfluoropolyether oil in the aluminum capillary tube body 1 naturally flowed out to complete the infusing; the anti-corrosion super-slippery aluminum capillary tube was prepared.

Corresponding to the above infusing treatment method, the present application provides the following two treatment solutions,

The steps of Solution 4.1 are: S411, an aluminum capillary tube sample modified by the low surface energy substance in Step 3 was taken for treatment, perfluoropolyether oil with a viscosity of 10-1000 Cst was added into a reagent bottle, the peristaltic pump was started according to the direction shown in FIG. 2, with a pumping flow rate of 5-120 mL/min and an ultrasonic frequency of 40-120 kHz, and the ultrasonic oscillation was continued in the process of introducing the reagents, and the reaction time was 0.5-18 h; S412, the treated aluminum capillary tube was vertically placed for 10-60 min, so that the excess perfluoropolyether oil in the aluminum capillary tube naturally flowed out, and then the preparation of the anti-corrosion super-slippery aluminum capillary tube was completed.

The steps of Solution 4.2 are: S421, an aluminum capillary tube sample modified by the low surface energy substance in Step 3 was taken for treatment, dimethyl silicone oil with a viscosity of 10-1000 Cst was added into a reagent bottle, the peristaltic pump was started according to the direction as shown in FIG. 2, with a pumping flow rate of 5-120 mL/min and an ultrasonic frequency of 40-120 kHz; ultrasonic oscillation was continued in the process of introducing the reagents, and the reaction time was 0.5-18 h; S422, the above treated aluminum capillary tube was vertically placed for 10-60 min, so that the excess dimethyl silicone oil in the aluminum capillary tube naturally flowed out, and then the preparation of the anti-corrosion super-slippery aluminum capillary tube was completed.

The main purpose of the above two solutions is to form a prewetting solution layer on the rough capillary structure surface of the inner wall of the aluminum capillary tube as shown in FIG. 2. Because the low surface energy modified layer 3 itself has functional groups of dimethyl silicone oil and perfluoropolyether oil, the prewetting solution can adhere to the modified layer under the double action of capillary force and Van der Waals force. On the one hand, the formation of prewetting solution layer can lubricate the flowing working medium in the aluminum capillary tube, and on the other hand, it can also isolate the corrosion of the flowing working medium to the aluminum substrate.

The above description shows the overall conception and treatment process of the present application, and the conception of the present application can also be confirmed in nature. The structural surface with special wettability effect in nature is the mouth edge surface of nepenthes. The mouth edge surface of the nepenthes locks the liquid equivalent to the surface prewetting solution 4 through the microscopic rough structure with the surface equivalent to the alumina capillary structure surface 2, and forms a continuous liquid film on the mouth edge surface, thus playing a lubricating role, which can effectively make the insects parked on the mouth edge slide into the cage for predation. In addition to lubrication, the liquid film also has a natural protective effect on the surface of the mouth edge, preventing the surface from being eroded by the outside world. Therefore, the aluminum capillary tube of the present application is an aluminum capillary tube with the inner wall of SLIPS with nepenthe-like effect. The method for preparing slippery liquid infused porous surface (SLIPS) on the inner wall of the aluminum capillary tube ensures that the inner wall of the aluminum capillary tube has corrosion resistance and lubrication and drag reduction effects on the flow, so that the aluminum capillary tube has dual anti-corrosion and super-slippery capabilities. Finally, on the basis of the above aluminum capillary tube examples with a specific size, the beneficial effect of the invented aluminum capillary tube was verified by taking the gallium-based liquid metal with corrosiveness and high viscosity as an example.

According to the present application, an aluminum capillary tube sample with the inner diameter of 652 μm was measured, and the beneficial effects of flow enhancement and corrosion resistance were verified.

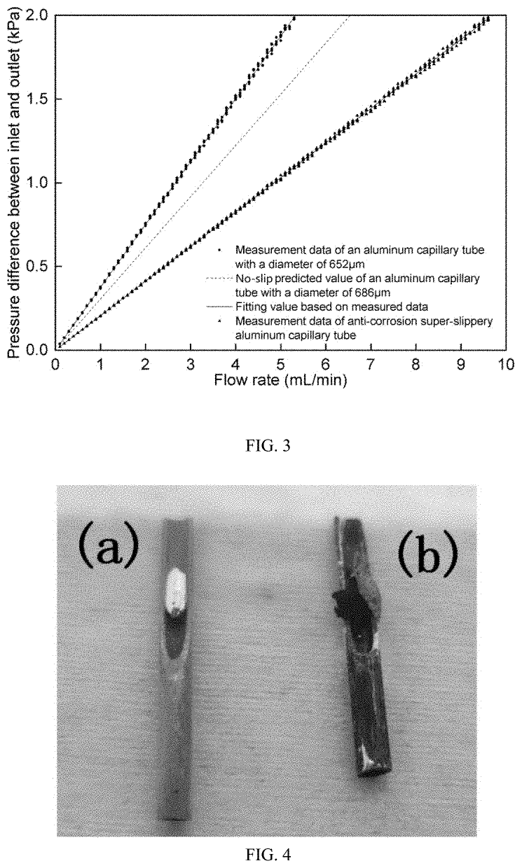

Firstly, the flow enhancement (super-slippery effect) was verified by using water as the working fluid. FIG. 3 shows the relationship between the measured pressure drop and the flow rate at both ends of a 10 cm aluminum capillary tube. The change of pressure loss along the aluminum capillary tube was monitored by controlling the flow rate. Due to various treatment processes involved in the preparation of the inner wall of the aluminum capillary tube, the inner diameter of the aluminum capillary tube changed from 652 μm before preparation to 686 μm after preparation. In the figure, the circular black dots are the measured result in the pure aluminum capillary (inner diameter of 652 μm) before treatment, the black solid line running through the circular black dots are the fitting curve made according to the test point, and the black dotted line is the predicted value of the prepared anti-corrosion super-slippery aluminum capillary tube (with an inner diameter of 686 μm) under the assumption that the wall surface has no lubrication (no slip) based on Poiseuille flow theory. The calculation formula of the Poiseuille flow theory in the circular tube is:

$$Q = \frac{π {D}^{4} Δ P}{128 μ L} ,$$

where Q is the flow rate, D is the diameter of the capillary tube, ΔP is the pressure difference, μ is the fluid viscosity, and L is the channel length. The triangle black dot is the measured result of the anti-corrosion super-slippery aluminum capillary tube with the inner diameter of 686 μm, and the solid line running through the triangle black dot is the fitting curve made according to the test point. As can be seen from FIG. 3, under the same flow rate, the pressure loss along the anti-corrosion super-slippery aluminum capillary tube is greatly reduced, and it has obvious drag reduction and lubrication effect.

Secondly, gallium-based liquid metal (Ga₆₈In₂₀Sn₁₂) was used as the flowing working medium to test the corrosion resistance. FIG. 4 compares the characteristics of the gallium-based liquid metal in a super-slippery anti-corrosion aluminum capillary tube and a common aluminum capillary tube. FIG. 4(a) shows the situation of the gallium-based liquid metal in the anti-corrosion super-slippery aluminum capillary tube. It can be seen that the liquid metal still shows bright metallic luster, does not react with the aluminum substrate, and still has fluidity, which indicates that there is no direct contact between the liquid metal and the aluminum substrate. However, in the pure aluminum capillary tube, as shown in FIG. 4(b), the gallium-based liquid metal directly contacts with the base of aluminum capillary tube and undergoes a violent embrittlement reaction, causing the inner wall of aluminum capillary tube and the liquid metal to appear black, at which time the liquid metal has lost its fluidity.

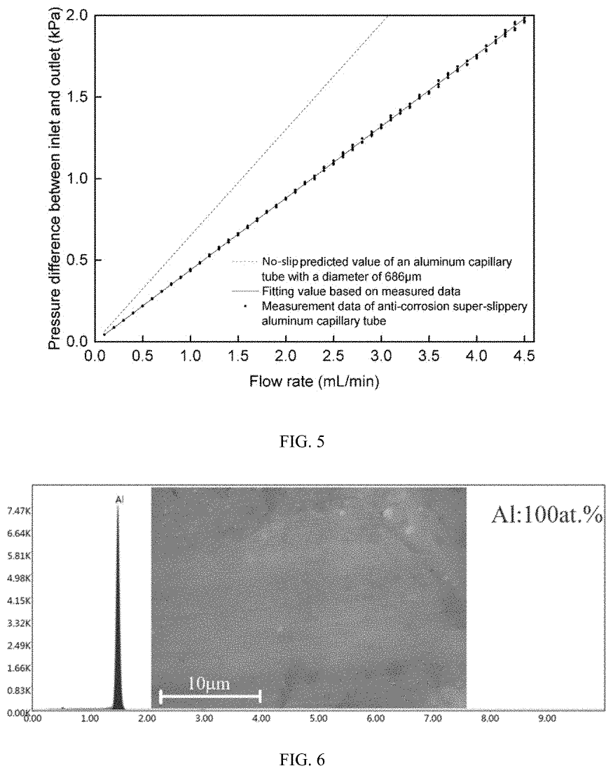

In order to further test the corrosion resistance and super-slippery performance of the aluminum capillary tube of the present application, the flow performance of the above gallium-based liquid metal (the dynamic viscosity of which is more than twice that of water) in the anti-corrosion super-slippery aluminum capillary tube with a diameter of 686 μm and a length of 10 cm was tested. The test method is similar to that of FIG. 3, and the results obtained are shown in FIG. 5. As gallium-based liquid metal has a strong corrosive effect on aluminum, as shown in FIG. 4(a), it is impossible to directly test the performance of the gallium-based liquid metal flowing in common aluminum capillary tubes. The black dotted line in FIG. 5 shows the result of the gallium-based liquid metal flowing in a pure aluminum capillary tube with an inner diameter of 686 μm, which is predicted based on the slip-free Poiseuille flow theory. The circular black dots show the measured result of the gallium-based liquid metal flowing in an anti-corrosion super-slippery capillary tube with an inner diameter of 686 μm, and the solid line running through the circular black dots show the fitting curve drawn according to the test dots. As can be seen from FIG. 5, the anti-corrosion super-slippery aluminum capillary tube can stably and continuously transport corrosive gallium-based liquid metal. In addition, compared with the slip-free aluminum capillary tube, the anti-corrosion super-slippery aluminum capillary tube has smaller pressure drop along the way, and has obvious slip effect on the wall, thus having obvious lubrication and drag reduction effect. To sum up, the aluminum capillary tube in the present application has good corrosion resistance, excellent drag reduction and energy saving effects, and has a wide application prospect.

The structure, treatment process and idea of the present application will be further explained and verified by combining the following specific treatment process of the aluminum capillary tube.

Step 1, pretreatment of an aluminum capillary tube: an aluminum capillary tube with an inner diameter of 652 μm was cut to 10 cm long, and the two ends of the aluminum capillary tube to be treated were connected with 13 # (national standard) high-elasticity anti-corrosion silicone tubes. The specific device is shown in FIG. 2.

The specific steps are as follows: (1) after adding acetone into a reagent bottle, a peristaltic pump was started according to the direction shown in FIG. 2, with a flow rate of 60 mL/min and an ultrasonic frequency of 60 kHz; ultrasonic oscillation was continued in the process of introducing the reagent, and the reaction time was 20 min; (2) for the above treated aluminum capillary tube, after adding alcohol into the reagent bottle, the peristaltic pump was started according to the direction shown in FIG. 2, the flow rate of the peristaltic pump was 60 mL/min, the ultrasonic frequency was set at 60 kHz, and the ultrasonic oscillation was continued during the process of introducing the reagent, and the reaction time was 20 min; (3) for the above treated aluminum capillary tube, after adding deionized water into the reagent bottle, the peristaltic pump was started according to the direction shown in FIG. 2, the flow rate of the peristaltic pump was 60 mL/min, the ultrasonic frequency was set at 60 kHz, and the ultrasonic oscillation was continued during the process of introducing the reagent, and the reaction time was 15 min; (4) for the above treated aluminum capillary tube, after adding 2.5 mol/L hydrofluoric acid into the reagent bottle, the peristaltic pump was started according to the direction shown in FIG. 2, the flow rate of the peristaltic pump was 40 mL/min, the ultrasonic frequency was set at 30 kHz, and the reaction time was 15 min; the purpose of this step is to remove the naturally generated oxide layer on the surface; (5) for the above treated aluminum capillary tube, after adding deionized water into the reagent bottle, the peristaltic pump was started according to the direction as shown in FIG. 2, the flow rate of the peristaltic pump was 60 mL/min, and the ultrasonic frequency was set at 80 kHz; the ultrasonic oscillation was continued in the process of introducing deionized water, and the cleaning time was 15 min; the purpose of this step was to remove excess hydrofluoric acid from the inner wall of the aluminum capillary tube. The micro-morphology (SEM) and element composition (EDS) of the inner wall of the treated aluminum capillary tube are shown in FIG. 6. As can be seen from FIG. 6, the inner wall of the cleaned aluminum capillary tube is smooth and clean without impurities, and there is no micro-nano scale capillary structure on the surface. The element composition is only aluminum.

Step 2, chemical etching of the inner wall of the aluminum capillary tube: the purpose of this step is to form a capillary structure with a micro-nano scale roughness on the inner wall of the aluminum capillary tube. The device used is shown in FIG. 2. The concrete steps are as follows: (1) the pretreated aluminum capillary tube was taken for treatment, 3.5 mol/L hydrochloric acid was added to a reagent bottle, and then the peristaltic pump was started according to the direction shown in FIG. 2, the flow rate of the peristaltic pump was 65 mL/min, the ultrasonic frequency was set at 60 kHz, and the ultrasonic oscillation was continued in the process of introducing reagents, and the reaction time was 12 min; (2) the steps (1)-(3) in the above step were repeated to clean the surface of the chemically etched aluminum capillary tube, and then the tube was put in a high-temperature oven at 140° C. for 6 minutes to remove the moisture on the inner wall surface of the aluminum capillary tube. In the above process, there are two main chemical reactions on the inner wall of the aluminum capillary tube. In step 2 (1), aluminum contacted with the hydrochloric acid solution and the following reactions occurred:

2Al+6H⁺→2Al³⁺+3H₂↑

Al₂O₃+6H⁺=2Al³⁺+3H₂O

This reaction makes the inner wall of the aluminum capillary tube produce a large number of capillary structures with a micro-nano scale roughness. In step 2 (2), the following reactions occurred during high-temperature drying:

2Al+6H₂O=2Al(OH)₃↓+3H₂↑

4Al+3O₂=2Al₂O₃

2Al(OH)₃≙Al₂O₃+3H₂O

At a high temperature, aluminum reacts with water to form aluminum hydroxide, but aluminum hydroxide will decompose in a high temperature to form aluminum oxide. After the reaction, the inner wall of the aluminum capillary tube is mainly aluminum oxide.

The purpose of this step 2 is to generate a capillary structure with a micro-nano scale roughness on the inner wall of the aluminum capillary tube. The micro-morphology (SEM) and element composition (EDS) of the inner wall of the aluminum capillary tube after the above treatment are shown in FIG. 7. It can be seen from FIG. 7 that the etched inner wall of the aluminum capillary tube forms a capillary structure with a micro-nano scale roughness, and oxygen element is added in the element composition based on the aluminum element.

Since the substrate is an aluminum substrate, excessive aluminum may be present during EDS detection.

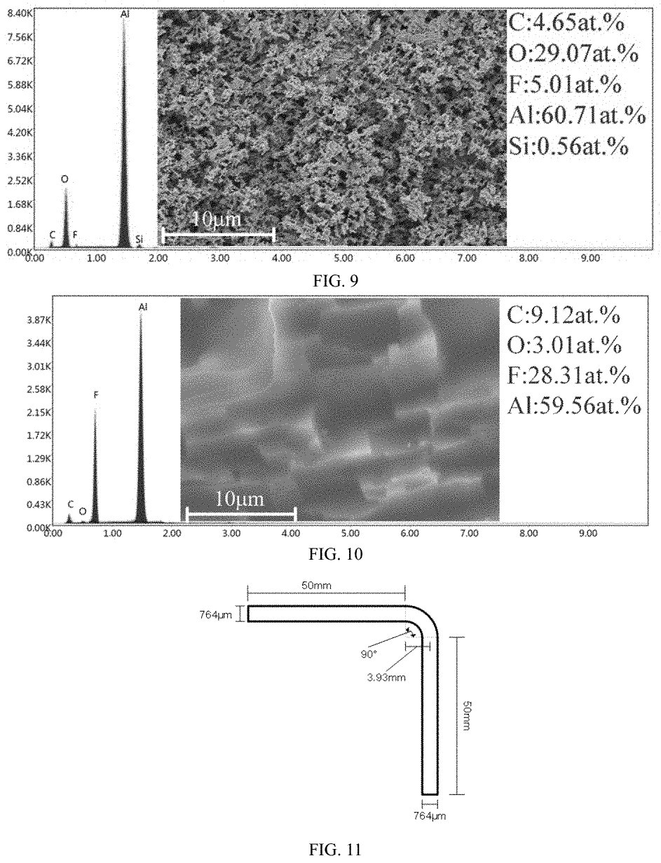

Step 3, modification of the inner wall of the aluminum capillary tube: the modified substance with low surface energy adhered to the inner wall of the aluminum capillary tube with capillary structures through deposition and reaction, and the capillary structure could effectively increase the adhesion amount of the substance with low surface energy. The specific steps are as follows: (1) the treated aluminum capillary tube sample in the above step was treated, 13 # anti-corrosion silicone tubes were selected for connection, a 2 wt. % ethanol solution of perfluorooctyltrichlorosilane was added into the reagent bottle, and the peristaltic pump was started according to the direction as shown in FIG. 2, with a pumping flow rate of 80 mL/min, the temperatures of the hotplate and the ultrasonic cleaning pool 21 were set at 85° C., the ultrasonic frequency was set at 60 kHz, and ultrasonic oscillation was continued in the process of introducing reagents, and the reaction time was 200 min; (2) the treated aluminum capillary tube was put into an oven at 150° C. and dried for 80 min. Because there was a trace amount of moisture in the perfluorooctyltrichlorosilane solution in ethanol (as shown in FIG. 8(a)), perfluorooctyltrichlorosilane would be hydrolyzed (as shown in FIG. 8(b)), and the trace amount of moisture in the rough structure near the inner wall of the aluminum capillary tube would react with the alumina surface to form hydroxyl groups on the substrate surface (as shown in FIG. 8(c)). In the high temperature environment of the oven (>120° C.), the hydrolyzed perfluorooctane trichlorosilane (FIG. 8(b)) underwent a dehydration condensation reaction with the hydroxyl-containing substrate (FIG. 8(c)) to firmly adhere to the inner wall surface and have dense —CF₃ groups (as shown in FIG. 8(d)). There was a strong van der Waals force between the —CF₃ group and the perfluoropolyether oil pre-wetting solution in the next step, which could ensure the good adhesion of the perfluoropolyether oil pre-wetting solution onto the surface. The micro-morphology (SEM) and element composition (EDS) of the inner wall of the aluminum capillary tube after the above treatment are shown in FIG. 9. It can be seen from FIG. 9 that the microstructure of the inner wall of the modified aluminum capillary tube is not obviously different from that of the chemically etched surface, but the elements such as carbon, oxygen, fluorine and silicon are added in the element composition. Because the substrate is an alumina substrate, excessive aluminum and oxygen elements will appear in EDS detection.

Step 4, infusing of the surface prewetting solution 4: the preparation of the anti-corrosion super-slippery aluminum capillary tube is completed through this step, and the specific steps are as follows: (1) an aluminum capillary tube sample treated in the above step was treated, and after adding perfluoropolyether oil with a viscosity of 20 Cst into the reagent bottle, the peristaltic pump was started according to the direction shown in FIG. 2, with a pumping flow rate of 10 mL/min and an ultrasonic frequency of 80 kHz, and the ultrasonic oscillation was continued during the process of introducing the reagent and the reaction time was 12 h; (2) the treated aluminum capillary tube was vertically placed for 40 min, so that the excess perfluoropolyether oil in the aluminum capillary tube naturally flowed out, and the preparation of the anti-corrosion and super-slippery aluminum capillary tube was completed. The main purpose of treating the above-mentioned aluminum capillary tube is to form the anti-corrosion prewetting solution layer as shown in FIG. 1. Because the inner wall of the aluminum capillary tube treated by surface chemical etching has a capillary structure, which has a larger surface area than that of the untreated aluminum capillary tube, and the modified layer itself has functional groups of hydrophilic dimethyl silicone oil and perfluoropolyether oil, the anti-corrosion prewetting solution can firmly adhere to the inner wall of the aluminum capillary tube under the double action of capillary force and Van der Waals force, thus effectively preventing the corrosion of the working medium flowing in the aluminum capillary tube to the aluminum substrate, and lubricating and reducing the drag of the flow. The micro-morphology (SEM) and element composition (EDS) of the inner wall of the aluminum capillary tube after the above treatment are shown in FIG. 10. It can be seen from FIG. 10 that the inner wall of the aluminum capillary tube infused with prewetting solution still has a certain rough capillary structure, but the surface SEM image is blurred compared with that of FIGS. 6, 7 and 9 due to the difference of the reflection intensity of the surface prewetting solution 4 to electrons. The content of fluorine in the elements has increased greatly, so it can be concluded that the pre-wetting solution has successfully adhered to the inner wall of the aluminum capillary tube.

In addition to the traditional straight aluminum capillary tube, the preparation solution of the anti-corrosion super-slippery aluminum capillary tube provided by the present application can be applied to application scenarios such as multi-elbow, variable cross-section, coiled tube and hose, etc., for example, an aluminum capillary tube with 90° right angle. The right-angle bent aluminum capillary tube implemented in the present application is shown in FIG. 11. The inner diameter of the right-angle bent aluminum capillary tube after surface etching is 764 μm (which is 748 μm before etching). The right-angle bent aluminum capillary tube has a 90° corner, and the radius of the corner is 3.93 mm.

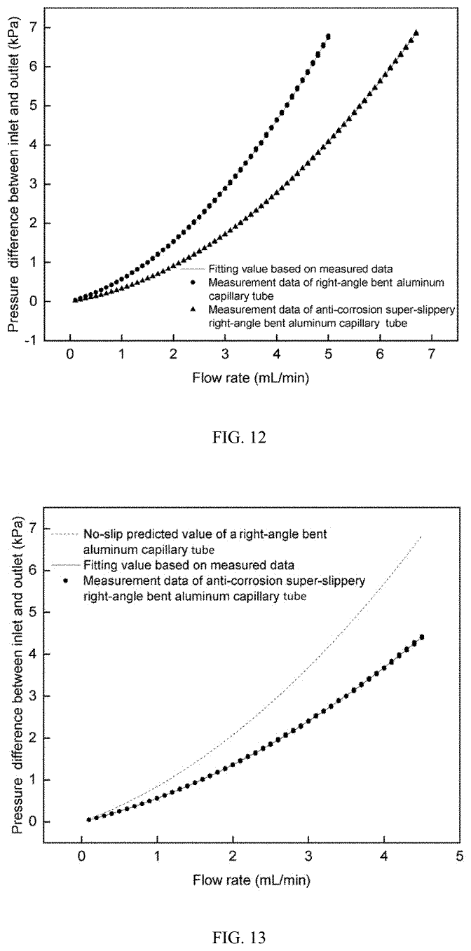

The circular black dots in FIG. 12 are the actual measurement results of the pure aluminum right-angle bent aluminum capillary tube (inner diameter is 748 μm) before treatment, and the black solid line running through the circular black dots is a fitting curve made according to the test dots. The triangle black dots are the actual measurement result of the anti-corrosion super-slippery right-angle bent aluminum capillary tube with an inner diameter of 764 μm, and the solid line running through the triangle black dots is a fitting curve made according to the test dots. As can be seen from FIG. 12, under the same flow rate, the pressure loss along the anti-corrosion super-slippery right-angle bent aluminum capillary tube is greatly reduced, and it has obvious drag reduction and lubrication effect.

In order to further test the corrosion resistance and super-slippery performance of the right-angle bent aluminum capillary tube of the present application, the flow performance of the above gallium-based liquid metal (the dynamic viscosity of which is more than twice that of water) in the anti-corrosion super-slippery right-angle bent aluminum capillary tube with a diameter of 764 μm and a geometric structure as shown in FIG. 11 was tested. The results obtained are shown in FIG. 13. The black dotted line in FIG. 13 shows the result of the gallium-based liquid metal flowing in a right-angle bent aluminum capillary tube with an inner diameter of 764 μm, which is predicted based on the no-slip Poiseuille flow theory. The circular black dots show the measured result of the gallium-based liquid metal flowing in an anti-corrosion super-slippery right-angle bent aluminum capillary tube with an inner diameter of 764 μm, and the solid line running through the circular black dots show the fitting curve drawn according to the test dots. As can be seen from FIG. 13, the anti-corrosion super-slippery right-angle bent aluminum capillary tube can stably and continuously transport corrosive gallium-based liquid metal. In addition, compared with the no-slip right-angle bent aluminum capillary tube, the anti-corrosion super-slippery right-angle bent aluminum capillary tube has smaller pressure drop along the way, less elbow loss, and has obvious slip effect on the wall, thus having obvious lubrication and drag reduction effect.

What is claimed is:

1. A method for preparing an anti-corrosion super-slippery aluminum capillary tube, comprising:
cleaning and removing a naturally generated oxide layer on the inner wall of the aluminum capillary tube body (1) for pretreatment;
etching the inner wall of the aluminum capillary tube body (1) after the pretreatment by chemical reactions under the joint action of heating and ultrasound to form a capillary structure with micro-nano scale roughness, and cleaning the capillary structure;
drying the capillary structure at a temperature of 60° C. to 165° C. to remove the surface moisture, thereby forming the alumina capillary structure surface (2);
adhering, by wetting, the prewetting solution (4) to the alumina capillary structure surface (2) to obtain the anti-corrosion super-slippery aluminum capillary tube.

2. The method for preparing an anti-corrosion super-slippery aluminum capillary tube according to claim 1, wherein the inner wall of the aluminum capillary tube body (1) after the pretreatment is etched and dried by any of the following methods to form the alumina capillary structure surface (2) with micro-nano scale roughness:
a. feeding 2.5 mol/L to 6 mol/L hydrochloric acid into the aluminum capillary tube body (1) to etch the inner wall of the tube at a pumping flow rate of 5 mL/min to 120 mL/min and an ultrasonic frequency of 40 kHz to 120 kHz, with the etching time lasting for 5 min to 30 min; drying the etched aluminum capillary tube at a temperature of 120° C. to 165° C. for 3 min to 15 min after the etching is finished and the cleaning is carried out;
b. feeding a mixed solution of 0.005 mol/L to 1 mol/L copper nitrate and 0.1 mol/L to 4 mol/L sodium chloride into the aluminum capillary tube body (1) to etch the inner wall of the tube at a pumping flow rate of 5 mL/min to 240 mL/min and an ultrasonic frequency of 40 kHz to 120 kHz under a temperature of 30° C. to 55° C., with the etching time lasting for 35 min to 160 min; drying the etched aluminum capillary tube at a temperature of 60° C. to 100° C. for 30 min to 120 min after the etching is finished and the cleaning is carried out;
c. feeding a mixed solution of 0.15 mol/L to 0.5 mol/L oxalic acid and 0.1 mol/L to 2 mol/L sodium chloride into the aluminum capillary tube body (1) to etch the inner wall of the tube at a pumping flow rate of 5 mL/min to 240 mL/min and an ultrasonic frequency of 40 kHz to 120 kHz under a temperature of 30° C. to 55° C., with the etching time lasting for 8 h to 16 h; drying the etched aluminum capillary tube at a temperature of 60° C. to 100° C. for 30 min to 120 min after the etching is finished and the cleaning is carried out;
d. feeding a mixed solution of 0.35 mol/L to 0.95 mol/L phosphoric acid, 0.05 mol/L to 0.25 mol/L sodium chloride and 0.05 mol/L to 0.2 mol/L chromium trioxide into the aluminum capillary tube body (1) to etch the inner wall of the tube at a pumping flow rate of 5 mL/min to 240 mL/min and an ultrasonic frequency of 40 kHz to 120 kHz under a temperature of 30° C. to 45° C., with the etching time lasting for 5 min to 20 min; drying the etched aluminum capillary tube at a temperature of 60° C. to 100° C. for 30 min to 120 min after the etching is finished and the cleaning is carried out;
e. feeding a 0.5 mol/L to 2 mol/L ferric chloride solution into the aluminum capillary tube body (1) to etch the inner wall of tube at a pumping flow rate of 5 mL/min to 240 mL/min and an ultrasonic frequency of 40 kHz to 120 kHz, with the etching time lasting for 0.5 min to 60 min; drying the etched aluminum capillary tube at a temperature of 60° C. to 80° C. for 30 min to 80 min after the etching is finished and the cleaning is carried out;
f. feeding a mixed solution of 0.01 mol/L to 0.4 mol/L oxalic acid and 0.2 mol/L to 2 mol/L hydrochloric acid into the aluminum capillary tube body (1) to do a primary etching of the inner wall of the tube at a pumping flow rate of 5 mL/min to 240 mL/min and an ultrasonic frequency of 40 kHz to 120 kHz, with the primary etching time lasting for 8 h to 24 h; after the primary etching is finished and the cleaning is carried out, feeding a 0.2 mol/L to 0.8 mol/L potassium permanganate solution into the aluminum capillary tube body (1) to do a secondary etching of the inner wall of the tube at a pumping flow rate of 5 mL/min to 240 mL/min and an ultrasonic frequency of 40 kHz to 120 kHz under a temperature of 30° C. to 45° C., with the secondary etching time lasting for 0.5 h to 2 h; drying the etched aluminum capillary tube at a temperature of 60° C. to 80° C. for 30 min to 80 min after the secondary etching is finished and the cleaning is carried out;
g. feeding a 0.5 mol/L to 12 mol/L sodium hydroxide solution into the aluminum capillary tube body (1) to do a primary etching of the inner wall of the tube at a pumping flow rate of 5 mL/min to 240 mL/min and an ultrasonic frequency of 40 kHz to 120 kHz, with the primary etching time lasting for 10 min to 60 min; after the primary etching is finished and the cleaning is carried out, carrying out a primary drying at a temperature of 60° C. to 80° C. for 30 min to 80 min; after the primary drying, feeding a mixed solution of 0.005 mol/L to 0.025 mol/L zinc nitrate hexahydrate and 0.005 mol/L to 0.05 mol/L sodium citrate into the aluminum capillary tube body (1) to do a secondary etching of the inner wall of the tube at a pumping flow rate of 5 mL/min to 240 mL/min and an ultrasonic frequency of 40 kHz to 120 kHz under a temperature of 60° C. to 90° C., with the secondary etching time lasting for 20 min to 80 min; drying the etched aluminum capillary tube at a temperature of 60° C. to 80° C. for 30 min to 80 min after the secondary etching is finished and the cleaning is carried out.

3. The method for preparing an anti-corrosion super-slippery aluminum capillary tube according to claim 1, further comprising:
modifying the alumina capillary structure surface (2) with stearic acid, palmitic acid or fluorosilane under the joint action of heating and ultrasound, and forming a low surface energy modifying layer (3) after modification;
adhering, by wetting, the surface prewetting solution (4) to the alumina capillary structure surface (2) with the low surface energy modifying layer (3).

4. The method for preparing an anti-corrosion super-slippery aluminum capillary tube according to claim 3, wherein in the step of modifying the alumina capillary structure surface (2) with stearic acid, palmitic acid or fluorosilane under the joint action of heating and ultrasound, and forming a low surface energy modifying layer (3) after modification, the modification is specifically achieved by any of the following methods:
a. feeding a 0.5 wt. % to 5 wt. % perfluorodecyltriethoxysilane solution in ethanol into the aluminum capillary tube body (1) to modify the alumina capillary structure surface (2) at a pumping flow rate of 5 mL/min to 120 mL/min and an ultrasonic frequency of 40 kH to 120 kH under a temperature of 60° C. to 95° C., with the modifying time lasting for 5 min to 900 min; drying the modified alumina capillary structure surface at a temperature of 60° C. to 160° C. for 20 min to 80 min after the modification is finished and the cleaning is carried out;
b. feeding a 0.05 mol/L stearic acid solution in ethanol into the aluminum capillary tube body (1) to modify the alumina capillary structure surface (2) at a pumping flow rate of 5 mL/min to 120 mL/min and an ultrasonic frequency of 40 kH to 120 kH under a temperature of 60° C. to 95° C., with the modifying time lasting for 5 min to 900 min; drying the modified alumina capillary structure surface at a temperature of 60° C. to 160° C. for 20 min to 80 min after the modification is finished and the cleaning is carried out;
c. feeding a 0.5 wt. % to 5 wt. % perfluorooctyltrichlorosilane solution in ethanol into the aluminum capillary tube body (1) to modify the alumina capillary structure surface (2) at a pumping flow rate of 5 mL/min to 120 mL/min and an ultrasonic frequency of 40 kH to 120 kH under a temperature of 60° C. to 95° C., with the modifying time lasting for 5 min to 900 min; drying the modified alumina capillary structure surface at a temperature of 60° C. to 160° C. for 20 min to 80 min after the modification is finished and the cleaning is carried out.

5. The method for preparing an anti-corrosion super-slippery aluminum capillary tube according to claim 1, wherein the step of adhering, by wetting, the surface prewetting solution (4) to the alumina capillary structure surface (2) specifically comprises:
adhering, by wetting, a perfluoropolyether oil or a dimethyl silicone oil with the viscosity of 10 Cst to 1000 Cst as the surface prewetting solution (4) to the alumina capillary structure surface (2) with the low surface energy modifying layer (3) under the action of ultrasonic oscillation.

6. The method for preparing an anti-corrosion super-slippery aluminum capillary tube according to claim 5, wherein the step of adhering, by wetting, a perfluoropolyether oil or a dimethyl silicone oil with a viscosity of 10 Cst to 1000 Cst as the surface prewetting solution (4) to the alumina capillary structure surface (2) with the low surface energy modifying layer (3) under the action of ultrasonic oscillation specifically comprises the following steps:
feeding a perfluoropolyether oil or a dimethyl silicone oil with a viscosity of 10 Cst to 1000 Cst into the aluminum capillary tube body (1) to infuse the modified alumina capillary structure surface (2) with the surface prewetting solution (4) at a pumping flow rate of 5 mL/min to 120 mL/min and an ultrasonic frequency of 40 kHz to 120 kHz, with the infusing time lasting for 0.5 h to 18 h; vertically placing the aluminum capillary tube body (1) for 10 min to 60 min after the infusion is finished, so that the excess perfluoropolyether oil in the aluminum capillary tube body (1) naturally flows out to finish the infusing process; finally obtaining the anti-corrosion super-slippery aluminum capillary tube.

7. An anti-corrosion super-slippery aluminum capillary tube prepared by the method according to claim 1, comprising:
an aluminum capillary tube body (1);
an alumina capillary structure surface (2) with micro-nano scale roughness formed by sequentially etching, cleaning and drying the inner wall of the aluminum capillary tube body (1);
a surface prewetting solution (4) adhering, by wetting, to the alumina capillary structure surface (2).

8. The anti-corrosion super-slippery aluminum capillary tube according to claim 7, wherein,
the alumina capillary structure surface (2) is modified by stearic acid, palmitic acid or fluorosilane to form a low surface energy modifying layer (3);
the surface prewetting solution (4) adheres, by wetting, to the low surface energy modifying layer (3).

9. The anti-corrosion super-slippery aluminum capillary tube according to claim 7, wherein the inner diameter of the aluminum capillary tube body (1) ranges from 200 μm to 1000 μm.

10. The anti-corrosion super-slippery aluminum capillary tube according to claim 7, wherein the surface prewetting solution (4) is perfluoropolyether oil or dimethyl silicone oil with a viscosity of 10 Cst to 1000 Cst.

11. A device for preparing an anti-corrosion super-slippery aluminum capillary tube, comprising:
an ultrasonic cleaning pool (21) used for containing an aluminum capillary tube body (1) for ultrasonic oscillation;
hoses (22) connected to two ends of the aluminum capillary tube body (1);
a reagent source (23) connected to one end of the hose (22), wherein the reagent source (23) comprises a cleaning liquid, an etching liquid, a modifying liquid and a surface prewetting solution (4) that are supplied independently in sequence;
and a driving pump (24) which draws the liquid in the reagent source (23) into the hose (22); a waste liquid tank (26) connected with the hose (22) to store the liquid waste produced from the reactions taking place in the aluminum capillary tube body (1).

12. The device for preparing an anti-corrosion super-slippery aluminum capillary tube according to claim 11, wherein the reagent source (23) is placed in an oil bath (25) heated with a hotplate (27).
